(19) United States
(12) Patent Application Publication
(10) Pub. No.: US 2013/0014279 A1
(43) Pub. Date: Jan. 10, 2013

(54) SYSTEM FOR PROVIDING PRIVACY OF USER INFORMATION IN AN ONLINE SOCIAL NETWORK WITH INLINE EDITING OF PRIVACY LEVELS AND CUSTOMIZED PRIVACY GROUPS

(76) Inventor: Ethan Leland, San Francisco, CA (US)

(21) Appl. No.: 13/192,135

(22) Filed: Jul. 27, 2011

Related U.S. Application Data
(60) Provisional application No. 61/368,704, filed on Jul. 29, 2010.

(51) Int. Cl. G06F 21/00

(52) U.S. Cl. 726/28

(57) ABSTRACT

A method of displaying, editing, and enforcing privacy settings for individual pieces of information published on a website. Privacy selections are displayed next to the information they protect. A user interface is presented in response to user-interaction with the displayed privacy selections that allows further privacy selections. The privacy selections indicate which other users may view the associated information. These options may be in the form of tiers of users with granted access or privacy groups. The publishing user may customize the privacy options by creating new tiers or groups for inclusion in the selection interface. Privacy icons may be associated with the privacy options, and may be displayed to the publishing user next to protected information, allowing easy identification of currently selected privacy settings. The publishing user may also upload additional privacy icons. Other users who access the published information are shown only those pieces of information that they have the right to view, based on the selected privacy settings.

### CROSS-REFERENCES TO RELATED APPLICATIONS

This application claims the benefit of an priority to U.S. Provisional application No. 61/368,704 titled “System for providing privacy of user information in an online social network with inline editing of privacy levels and customized privacy groups” which was filed on 29 Jul. 2010, which application is hereby incorporated by references for all purposes allowable by law.

### FIELD OF THE INVENTION

The present invention relates generally to methods of internet security and privacy. Specifically, the invention, relates to methods for displaying, editing, and enforcing user privacy settings for information published on a website.

### BACKGROUND

In recent years, there has been a massive increase in the number of websites that allow users to publish personal information and other user generated content. Examples of these websites include social networks like Facebook (http://www.facebook.com) and Orkut (http://www.orkut.com), internet blogs like MySpace (http://www.myspace.com) and Wordpress (http://www.wordpress.com), and more specialized publishing websites like Twitter (http://www.twitter.com) and Flickr (http://www.flickr.com). These websites often allow users to publish personal information or other sensitive data such as event information, blog posts, user contributed articles, and pictures. It is sometimes advantageous for these publishing users to limit access to parts of their published materials.

Typically, websites that allow users to publish information also provide basic privacy controls. However, there is still a need for a method that allows a user to easily exercise granular control over published information. There is also a need for methods that better allow users to quickly and easily identify what privacy settings have been associated with their published data.

Many methods of providing internet privacy are known. A number of references describe potentially relevant features. Currently Facebook employs a method of tiered privacy settings, allowing or denying access to information based on four separate tiers. Facebook does not allow for user customization of the tier categories. Additionally, Facebook requires a user to visit a webpage that is separate from the information to be protected in order to edit privacy settings.

U.S. patent application Ser. No. 12/206,556, to Callahan et al., published Mar. 12, 2009, describes a method of modifying information pathways, each conveying data about one user to another, in response to changed privacy settings. The application does not include a method of displaying and editing those privacy settings on the same web-page as the information being protected, nor does the application disclose the use of metadata tags to determine privacy levels associated with individual pieces of information to be protected.

U.S. patent application Ser. No. 11/493,291 to Zuckerberg, published Feb. 21, 2008, describes methods of displaying selected privacy settings in the form of a privacy summary. The application does not describe the use of customizable privacy-icons to identify the selected privacy settings, nor the display of privacy information on the same webpage as the information being protected.

U.S. patent application Ser. No. 12/209,157 to Lehrman et al., published Oct. 22, 2009, describes privacy settings that screen information provided to an accessing user, based on the characteristics of that user or the number of common connections between the publishing and accessing user. The application does not disclose a method of allowing a publishing user to create custom privacy groups, nor does it disclose a method of displaying privacy settings.

U.S. patent application Ser. No. 12/394,284 to Krishnamurthy et al., published Oct. 29, 2009, describes a privacy method that allows a publishing user to create a minimum personal privacy level by selecting pieces of information that are automatically authorized for disclosure. The application does not disclose a method that authorizes access to published information based on an analysis of the accessing user.

U.S. Pat. No. 6,889,213, to Douvikas et al., published Aug. 18, 2005, describes methods that allow a user to create an electronic business card and apply privacy settings to individual pieces of information on the card by selecting one of three privacy icons representing “Private”, “Semi-Private”, or “Public” access to the information. The patent does not disclose the display of only the selected privacy settings in conjunction with a popup interface for editing privacy options. This is an important distinction, as displaying all of the selectable privacy settings makes it more difficult to determine what the current privacy settings are.

### BRIEF DESCRIPTION OF THE INVENTION

The summary of the invention presented herein is not intended to limit or define the invention, but rather to impart a general understanding of it. Further embodiments and discussion of the invention can be found in the Detailed Description section and in the Claims.

Some exemplary embodiments of the present invention provide methods for displaying selected privacy settings in the same location as the data they protect. In some embodiments, these settings are displayed in the form of customizable privacy icons.

Some exemplary embodiments provide methods of allowing privacy settings to be edited on the same web-page as the information that they protect through a popup interface. The privacy settings may comprise specifically defined user groups or criteria for access to information. Alternatively, the privacy settings may comprise tiered access levels allow access to information if an accessing user falls within or above a selected tier.

Additionally, some exemplary embodiments provide methods for creating, customizing and/or implementing privacy settings, such as privacy groups, tiers, and icons.

These methods can be employed, for example, on social networking websites to allow users to quickly determine the currently selected privacy levels by noting the privacy icons associated with their profile information, to edit privacy levels without having to navigate to a separate privacy page on the website, and to create customized privacy settings in order to have more granular control over the privacy of their published information.

### BRIEF DESCRIPTION OF THE DRAWINGS

In each drawing, the boxes containing the letter ‘I’ represent icons, and the boxes containing ‘P’ contain a user's profile picture.

FIG. 1. This Figure shows a schematic logic diagram illustrating the method of the invention. This relates to paragraphs [025-029].

FIG. 2. This figure illustrates the published information as viewed by a publishing user, accompanied by a pop-up window for changing privacy settings. This relates to paragraphs [030-031]. Note that the dark field in FIG. 2 is intended to be highlighted and should have the words “only me” in the highlighted box.

FIG. 3. This figure depicts several illustrative examples of pop-up windows for changing privacy settings. This relates to paragraphs [032-035].

FIG. 4. This figure illustrates an interface for adding and customizing privacy options. The center column contains the toggle for tiered privacy settings. When this option is selected each of the group rows in that column are draggable so the list can be re-ordered. Also depicted is a search tool for finding users to add to privacy groups or tiers, a window for viewing and removing members from existing privacy groups or tiers, an option to add new privacy groups or tiers, and an option to change the privacy icons associated with each privacy group or tier. This relates to paragraphs [036-040].

FIG. 5. This figure illustrates the privacy icon chooser that also allows for uploading custom icons. This relates to paragraph [040].

FIG. 6a, 6b, 6c. These figures depict an illustrative comparison between published information as viewed by the publishing user and by other users. This relates to paragraph [041].

FIG. 7. This figure illustrates a simplified computer system capable of carrying out the invention. This relates to paragraph [042].

### DETAILED DESCRIPTION OF THE INVENTION

The embodiments discussed herein comprise methods and systems for editing, displaying, and enforcing user privacy on a website where personal information and/or any user generated content can be selectively shown or not shown to other users, such as in a social networking website. The user-contributed information may include, for example, personal information (name, birthday, address), blog posts, user contributed articles, or event information.

### Illustrative Privacy Method:

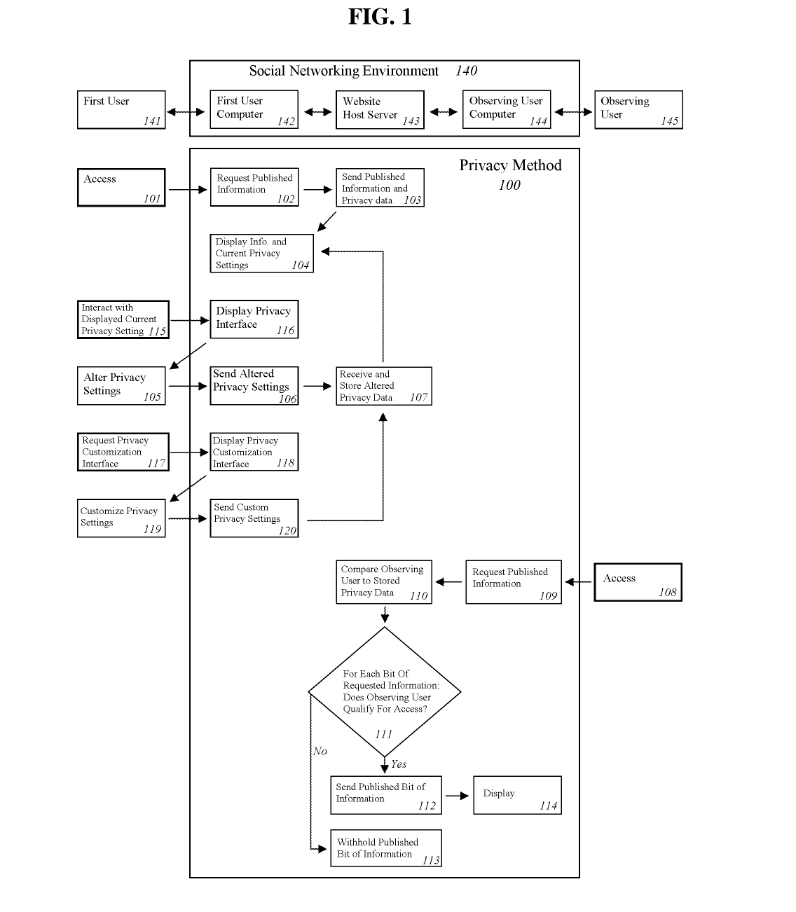

FIG. 1 shows an illustrative environment 140 that may be used to perform of the disclosed method 100. FIG. 1 depicts a social networking environment 140 that operates using a number of software components executing on at least one computer system, shown for purposes of illustration as a first user computer system 142 that may be interacted with by a First User 141, a Website Host Server 143, and an Observing User Computer system 144 that may be interacted with by an Observing User 145. While a network comprising at least three systems is depicted, the methods disclosed in the invention can be carried out on a single device. For the purpose of this illustration, the information-publishing user is referred to as the “First User” and the accessing user is referred to as the “Observing User”. The system components that comprise the social networking environment comprise computer processors having access to code for carrying out the methods described. For clarity, each of the system components is shown above the processes that it is responsible for facilitating.

According to illustrative Privacy Method 100, in response to a First User's 100 access of his or her published data (blocks 101, 102), the Website Host Server 143 sends a First User Computer system 142 information published by the First User 141 and privacy data associated with that information (block 103). The First User Computer system 142 displays the published information along with the currently selected privacy options have been associated with the published information (block 104).

If the First User 141 interacts with one of the displayed current privacy settings (block 115), the First User Computer system 142 displays an interface that allows the First User 141 to select a new privacy setting (block 116). In response to any such privacy selections by the First User 141 (block 105), the First User Computer system 142 sends the new privacy selections to the Website Host Server 143 (block 106). The Website Host Server 143 stores these selections (block 107). The displayed selected privacy settings are updated to reflect the new selection (block 104).

Some embodiments of the invention include a separate privacy customization interface which may be accessed by the First User 141 (block 117). The First User Computer system 142 displays this interface (block 118). If the First User makes any selections in this interface (block 119), the customization data is sent to the Website Host Server 143 where the data is stored (block 107). The displayed selected privacy settings are updated to reflect the customization (block 104).

When an Observing User 145 requests information published by the First User 142 from the Website Host Server 143 (blocks 108, 109), the Website Host Server compares the Observing User 145 to the privacy rules set by the First User 141 for each piece of requested information (block 110). If the privacy rule for a particular piece of information is satisfied (blocks 111, 112), that piece of information is displayed to the Observing User 145. If a privacy rule is not satisfied, the information that that rule is associated with is not displayed to the Observing User 145 (blocks 111, 113).

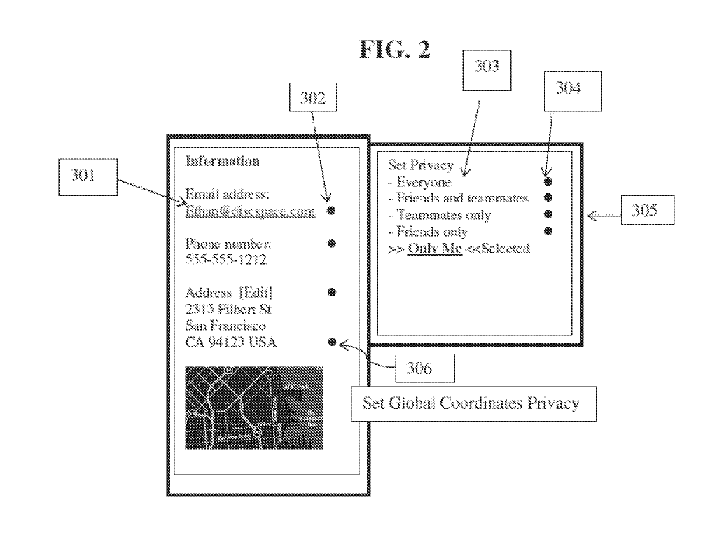

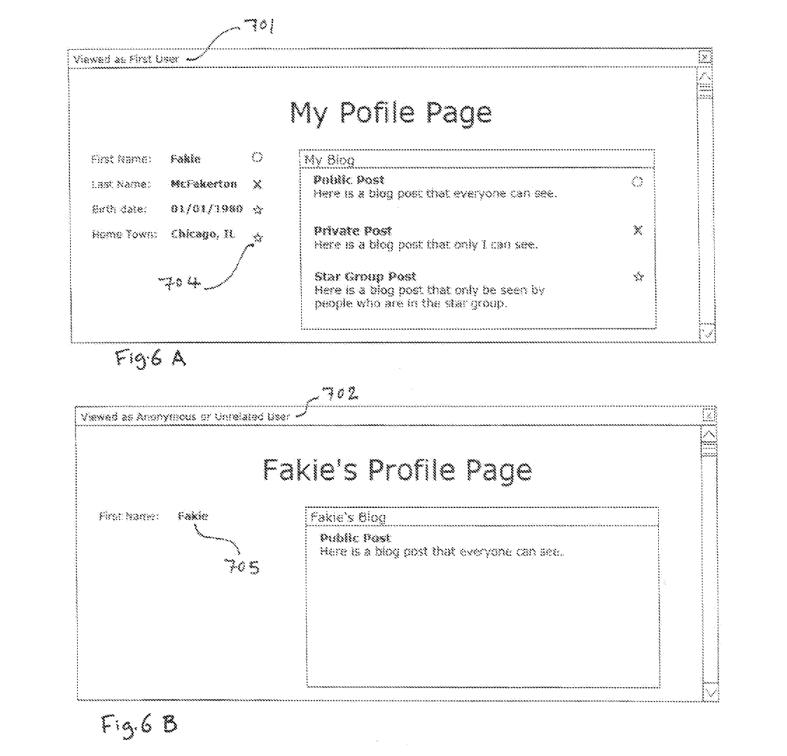

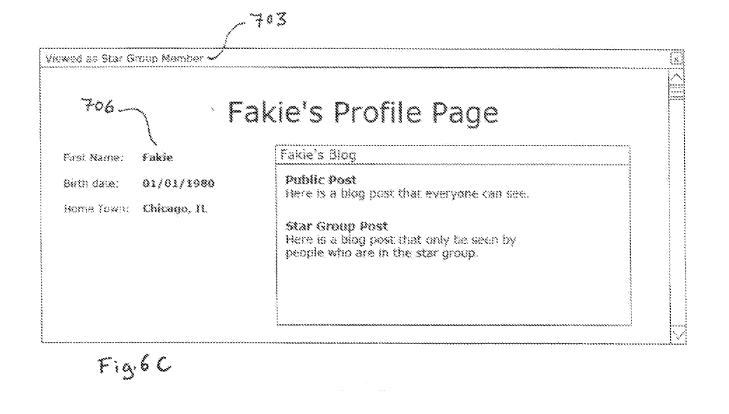

FIG. 2 shows an illustrative embodiment of the published information as viewed by the First User. In one embodiment, the selected privacy options 302 (and see FIG. 6: 704) are displayed in the same location as (or in close proximity to—see definitions) the published data that they are associated with 301. They may be displayed, for example on top of, directly above, below, or next to the published information.

In an embodiment, the published data, the selectable privacy options 303 are displayed without navigating to a new webpage when the publishing user interacts with the displayed selected privacy option 306. This may occur, for example, in a pop-up interface within the same webpage 305.

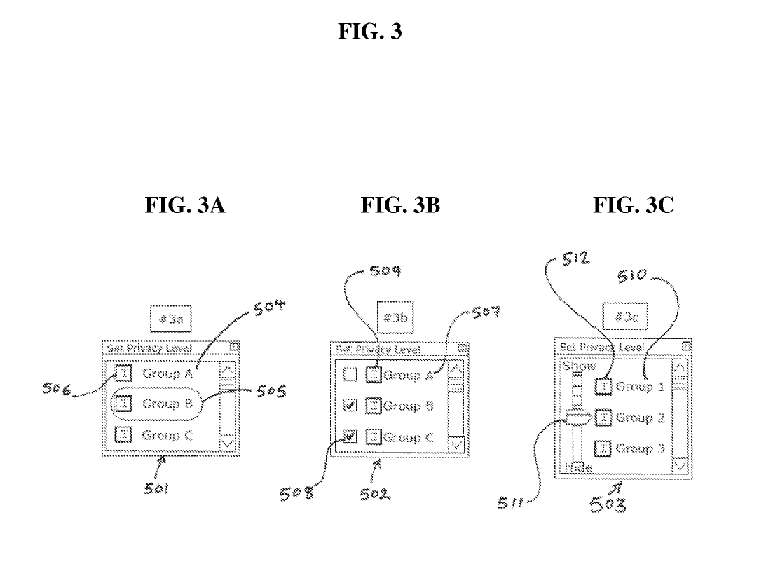

FIG. 3 depicts several alternative illustrative embodiments of the selectable privacy options as displayed to the publishing user. In one embodiment 501, the privacy options 504 are presented as a list, wherein one of the options may be selected 505. In another embodiment 502, the privacy options 507 are presented as a list with user-selectable check-boxes 508, wherein one or more of the privacy options may be selected.

In yet another embodiment 503, the privacy options 510 appear in the form of tiered groups and may appear in an ordered format, for example from most authority to least. The minimum authority to view the protected content may be selected from this list, for example, by selection of the group with the minimum authority to view the published information, or by a moveable selection marker indicating that same group 511. In an embodiment, the selectable options that are shown are pre-defined options. In another embodiment, they comprise user customized options.

In an embodiment, privacy icons FIG. 3: 506, 509, 512 & FIG. 2: 302, 304, 306 are associated with the selected and selectable privacy options. These icons may be displayed in the same location as their associated privacy option as in FIG. 2: 304 & FIG. 3: 506, 509, 512, or may be displayed in place of their associated privacy options as in FIG. 2: 302, 306. In an embodiment, privacy icons are displayed next to protected published information to indicate the currently selected privacy settings associated with the information.

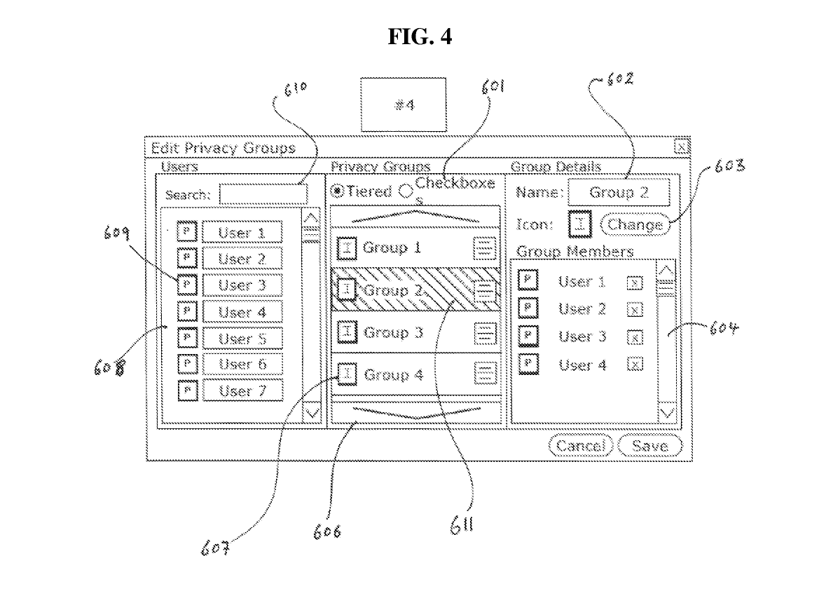

FIG. 4 depicts an illustrative embodiment of an interface, as it is displayed to the First User, that may be used to customize privacy options. In one embodiment, this interface comprises a selectable option to organize privacy settings either as tiered settings or as privacy groups 601. This option may exist, for example, as a toggle switch. In the same embodiment, this interface also comprises an option to create new privacy groups and tiers 605. In an embodiment, this interface comprises an input box for naming privacy options 602.

In an embodiment, the interface comprises an option to assign specific users to tiers or user groups 610, 608. This may be accomplished, for example, with a search field 610 for searching through users, who are then displayed 608 and able to be selected or moved into a privacy group. In an embodiment, pictures associated with the selectable users 609 are displayed next to their names.

In an embodiment, the authority of tiers is editable by dragging them into an ordered group. In an another embodiment, the authority tiers is editable through fields where numbers indicating authority can be inputted. In an embodiment, the interface comprises a tool for viewing and removing members currently assigned to tiers or groups 604. This may comprise, for example, a window displaying the users within a selected privacy group, along with a remove button next to each name for removing a selected member from that group. In an embodiment, the interface comprises an option to assign criteria for determining which users belong in specific tiers or user groups.

In an embodiment, the interface comprises an option to assign authority to the tiers 606. The tier authority assignment may comprise, for example, input fields for assigning numbers to the tiers or a list of available tiers that may be re-ordered.

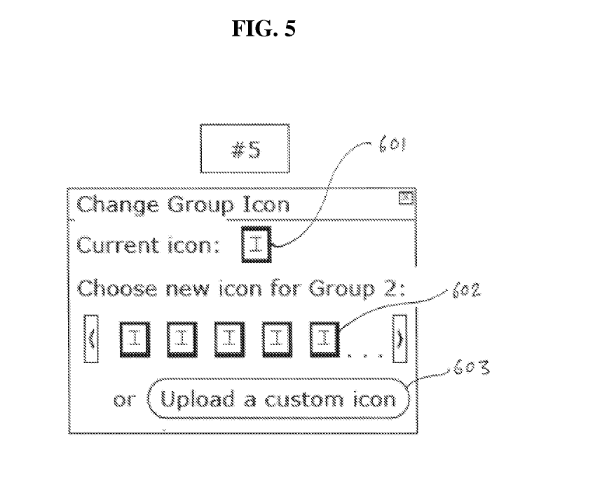

In an embodiment, this interface comprises an option 603 to assign or alter the privacy icons 607 associated with the privacy tiers and groups. FIG. 5 shows a more detailed illustrative embodiment of a menu for assigning or changing privacy icons. In one embodiment, the icons may be selected from a list 602 of pre-generated icons. In another embodiment, the icons may be selected from a list 602 comprising user-generated icons. In an embodiment, the interface comprises an option to upload new privacy icons 603.

FIGS. 6a, b and c depict an illustrative example comparison between the display of the published information to the publishing First User 701 (6a), to a first observing user that does not belong to any of the privacy groups 702 (6b), and to a second observing user belonging to one of the privacy groups 703 (6c). The privacy options and icons 704 are not displayed to either observing user 702, 703. Information that the observing users do not have permission to view is not shown. Any information on the webpage that the observing users do have permission to view is shown 705, 706.

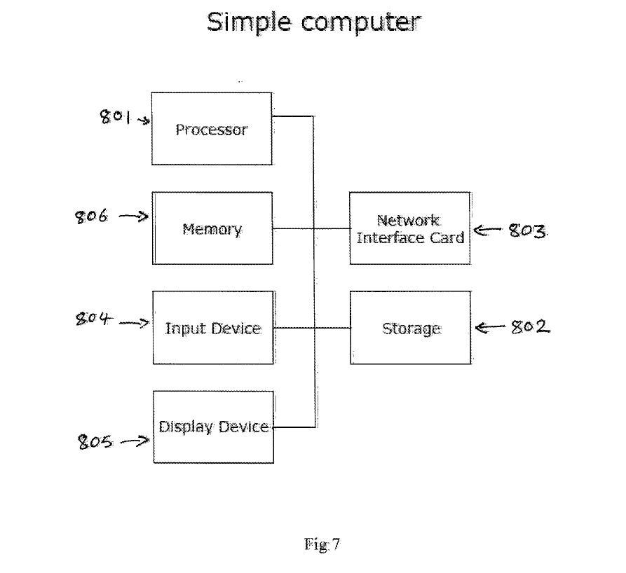

FIG. 7 depicts an illustrative example of the First User Computer system or the Observing User Computer system. These devices comprise a computer readable medium such as a hard drive or random access memory (RAM) 802 coupled to a processor 801. The processor 802 executes computer-executable program instructions stored in the computer readable medium 801. These devices may be connected by a network 803. In one embodiment, the network is the internet. In another embodiment, the network is a mobile phone network. In still further embodiments, other networks may be used, such as an intranet, WAN or LAN. These devices may also comprise a number of external or internal input devices 804 such as a mouse or keyboard. They also comprise one or more output devices 805 such as a computer monitor or a phone screen. The system may also comprise numerous other internal or external devices, such as a CD-ROM drive, a DVD drive, or other input or output devices. Examples of the described system includes personal computers, cellular phones, mobile phones, pagers, laptop computers, and digital tablets.

The foregoing description of embodiments should not be construed as limitations on the scope of the invention, but should instead be viewed as illustrative and exemplary only. Various modifications will be obvious to those skilled in the art without departing from the scope of the invention. The language is intended to be instructional, and it should be understood that any methods presented are to be carried out by a computing device.

### DEFINITIONS

Publishing user: Any user with permission to edit the privacy settings of the published information. Typically, this will be the user who initially published the information.

Accessing User: Any user attempting to access or view protectable published information without permission to edit the privacy settings of that information.

User Interface: An area of a webpage or a separate webpage populated with at least one option that the publishing user may interact with.

For example, a privacy option in the same location as protectable published information may be located anywhere near to the information, including above, below, next to, and on top of the information. Two objects in the “same location” will be within the same quadrant of the web page and may be separated by, for example no more than 4 inches, 3 inches or 2 inches or even 1 inch from each other on the web page. In terms of Pixels, the two objects in the “same location” may be, for example, no more than 10, 100, 200, 300, 400 or in some cases no more than 500 or even 750 pixels apart when viewed on a standard screen (for example a screen an a size between 6 inches and 22 inches diagonally).

Metadata Privacy String: A piece of data associated with a piece of protectable published information, which reflects the privacy settings enabled for that information.

Visitor Privacy String: A piece of data containing information about an accessing user. The information may comprise, for example, information on the relationship between the publishing user and the accessing user.

Interacting (with respect to users and webpage elements): Any method of selection. A user may interact with a webpage element such as a privacy icon by, for example, utilizing a mouse to click on or scroll over it, selecting by a scrollable menu, selecting by keyboard or keyboard shortcut (combination of keys), touching it on a touch-sensitive interface, or any other method of selection.

Current Privacy Settings: Any privacy settings that are selected or currently in effect.

Unselected Privacy Settings: Any privacy settings that are not currently in effect, but which may be selected, and thereby placed into effect, by an accessing user.

Popup Window: An interface within the current webpage that expands or appears in response to some action, and which contains information and/or selectable options. One illustrative example of a popup window can be found in FIG. 2, item 305.

Rights to View: Permission to view, as determined by privacy settings. This may, for example, include the status of “Friend”, “Not Friend”, “Spouse”, and “Family”. Additionally, the relationships may be indirect, such as “Friend of a Friend” “Teammate”, or “Member of Same Social Group”.

What is claimed is:

1. A system comprising a computer and a publishing user, wherein said computer comprises a memory programmed with a code, which code, when executed, directs a program allowing the publishing user to carry out a method to control the privacy level applied to protectable published information displayed on a website, the method comprising:
(i) displaying to a publishing user, on a single webpage, the protectable published information and the current privacy settings associated with said protectable published information, wherein each of said current privacy settings is displayed in the same location as its associated protectable published information;
(ii) presenting a user interface within the same said webpage in response to said publishing user interacting with the displayed said current privacy settings, the user interface enabling said publishing user to alter said current privacy settings;
(iii) determining whether an accessing user has rights to view said protectable published information based on the said current privacy settings associated with that said protectable published information; and
(iv) displaying to said accessing user only the said protectable published information that said accessing user has rights to view.

2. The system of claim 1 wherein said displaying to a publishing user step further comprises not displaying unselected privacy settings.

3. The system of claim 2 further comprising displaying two or more separate items of protectable published information wherein each item of protectable published information is associated with a current privacy setting and wherein the current privacy setting for one item of protectable published information may be the same or different from the current privacy setting for another item of protectable published information

4. The system of claim 2 wherein said user interface comprises a popup window within the same webpage.

5. The system of claim 4, wherein the displayed said current privacy settings are represented by and displayed in the form of privacy icons.

6. The system of claim 5, wherein each said current privacy setting determines a metadata privacy string for its associated said protectable published information, and wherein said determining step comprises:
(i) generating a visitor privacy string when said accessing user accesses said webpage; and
(ii) checking said visitor privacy string against said metadata privacy strings;

7. The system of claim 6, wherein said determining step comprises:
(i) looking up default site-wide relationships between said accessing user and said publishing user;
(ii) populating said visitor privacy string with all of said default site-wide relationships between said accessing user and said publishing user;
(iii) checking said visitor privacy string against said metadata privacy strings; and
(iv) allowing said accessing user to view the said protectable published information if said visitor privacy string and the said metadata privacy string associated with said protectable published information contain any of the same groups.

8. The system of claim 6, wherein said selectable privacy settings indicate tiered levels of access, wherein each of said tiered levels of access is associated with a number, wherein said number is assigned to said metadata privacy string;
and wherein said determining step comprises:
(i) populating said visitor privacy string with said number that is associated with the said tiered level of access to which said accessing user belongs;
(ii) checking said visitor privacy string against said metadata privacy strings; and
(iii) allowing said accessing user to view a said protectable published information if said visitor privacy string contains a number equal to or larger than the said metadata privacy string associated with said protectable published information.

9. The system of claim 6, further comprising:
(i) presenting a separate interface for customizing said selectable privacy settings, wherein said separate interface comprises:
(a) a selectable option to organize privacy settings either as tiered access groups or as individualized access groups, wherein said tiered access groups allow access to website information only if said accessing user belongs within a tier selected by said publishing user or within any higher tier, and wherein said individualized access groups allow access to website information only if said accessing user belongs within a group selected by said publishing user;
(b) a tiered access group assignment means for assigning users to said tiered access groups; and
(c) an individualized access group assignment means for assigning users to said individualized access groups;

10. The system of claim 9, wherein said tiered access group assignment means allows said publishing user to select criteria for automatically assigning users to said tiered access groups, and wherein said individualized access group assignment means allows said publishing user to select criteria for automatically assigning users to said individualized access groups.

11. The system of claim 9, wherein said separate user interface further comprises a privacy icon assignment means for selecting privacy icons to be associated with said tiered access groups and said individualized access groups;

12. The system of claim 11, wherein said separate user interface further comprises an upload means for uploading said privacy icons.

13. A system comprising a computer and a publishing user, wherein said computer comprises a memory programmed with a code, which code, when executed, directs a program allowing the publishing user to carry out a method to create customized privacy settings to be applied to information contained on a website, the method comprising:
(i) presenting a user interface to said publishing user for customizing said privacy settings, wherein said user interface comprises:
(a) a selectable option to organize said privacy settings either as tiered access groups or as individualized access groups, wherein said tiered access groups allow access to website information only if said accessing user belongs within a tier selected by said publishing user or within any higher tier, and wherein said individualized access groups allow access to website information only if said accessing user belongs within a group selected by said publishing user;
(b) a tiered access group assignment means for assigning users to said tiered access groups;
(c) an individualized access group assignment means for assigning users to said individualized access groups;

14. The system of claim 13, wherein said tiered access group assignment means allows said publishing user to select criteria for automatically assigning users to said tiered access groups, and wherein said individualized access group assignment means allows said publishing user to select criteria for automatically assigning users to said individualized access groups.

15. The system of claim 13, wherein said user interface further comprises a privacy icon assignment means for selecting privacy icons to be associated with said tiered access groups and said individualized access groups;

16. The system of claim 15, wherein said user interface further comprises an upload means for uploading said privacy icons.
